(19) United States
(12) Patent Application Publication
(10) Pub. No.: US 2005/0253782 A1
(43) Pub. Date: Nov. 17, 2005

(54) Plasma display apparatus and image processing method thereof

(76) Inventor: Jun Hak Lee, Suwon-si (KR)

Correspondence Address: MCKENNA LONG & ALDRIDGE LLP, 1900 K STREET, NW, WASHINGTON, DC, 20006, US

(21) Appl. No.: 11/129,295

(22) Filed: May 16, 2005

(30) Foreign Application Priority Data
May 14, 2004 (KR) 10-2004-0034466

(51) Int. Cl. G09G 3/28

(52) U.S. Cl. 345/60

(57) ABSTRACT

There are provided a plasma display apparatus and an image processing method thereof. The plasma display apparatus includes an inverse gamma correction unit performing inverse-gamma correction on image data applied from the outside; and a halftoning unit respectively applying different error coefficients to Red, Green, and Blue image data of the inverse-gamma corrected image data and performing error diffusion of the Red, Green, and Blue image data to which the different error coefficients are applied.

This Nonprovisional application claims priority under 35 U.S.C. § 119(a) on Patent Application No. 10-2004-0034466 filed in Korea on May 14, 2004 the entire contents of which are hereby incorporated by reference.

### BACKGROUND OF THE INVENTION

1. Field of the Invention

The present invention relates to a plasma display apparatus and an image processing method thereof.

2. Description of the Background Art

Generally, in a plasma display panel (PDP), unit cells are partitioned by barrier ribs formed between a front panel composed of a Soda-lime glass and a rear panel. Each cell is filled with main discharge gas, such as Ne, He, Ne−He mixture (Ne+He) and so on, and inert gas containing a small amount of Xe. When discharge occurs by a high frequency voltage, the inert gas generates vacuum ultraviolet rays and excites phosphors formed between the barrier ribs, thereby forming an image.

Such a PDP currently can be easily manufactured because it has a simple structure compared to a cathod-ray tube (CRT) which has been mainly used as a display apparatus. Also, the PDP currently is in the focus of attention as a next-generation display since it is thin in thickness and light in weight compared to the CRT.

FIG. 1 shows graphs for comparing the brightness characteristics of a conventional PDP with those of a CRT. As shown in FIG. 1, in a CRT and LCD (Liquid Crystal Display), since input video data is controlled in an analog manner to display light of a desired gray level, a non-linear brightness curve is obtained. Meanwhile, in a PDP, since the number of optical pulses is modulated using the matrix array of discharge cells which can be on/off controlled to thus represent a gray level, a linear brightness curve is obtained.

This PDP gray level representation method is called a Pulse Width Modulation (PWM) method. In this case, the brightness of the PDP linearly changes according to the number of pulses. However, since human eyes non-linearly sense the change in brighness, noise will be generated when a gray level is displayed in a low gray-level region. In order to solve this problem, in the PDP, input video data is subjected to inverse-gamma correction, as shown in FIG. 2.

FIG. 2 is a graph for explaining inverse-gamma correction in a conventional PDP. In FIG. 2, target brightness is an ideal brightness value, actual brightness is an actual brightness value measured after inverse-gamma correction, and PDP brightness is a brighness value smaller than 3, measured before inverse-gamma correction.

As shown in FIG. 2, ideally, 61 gray levels of 0-60 should be respectively represented by 61 different brightness values (target brightness). However, in the actural brightness, 61 gray levels of 0-60 are represented by 8 brightness values. Accordingly, when inverse-gamma correction is performed in a PDP, gray-level representation is insufficient in a low gray-level region, which causes contour noise in which images overlap.

One among various methods used for representing such insufficient gray levels of PDP is error diffusion halftoning when PDP image processing.

FIG. 3 is a block diagram for explaining image processing of a conventional PDP.

Referring to FIG. 3, an input signal is input to a gain controller via a gamma correction unit. The gain controller controls the gain of the input signal and transfers the result to a halftone correction unit. The halftone correction unit corrects the gray level value of the received signal using error diffusion, etc. The resultant corrected signal is applied to a panel and displayed on a screen.

FIGS. 4A and 4B are views for explaining an error diffusion method used in a conventional PDP, wherein FIG. 4A is a view for explaining a conventional spatial error diffusion method and FIG. 4B is a view for explaining a conventional inter-pixel error diffusion method.

As shown in FIG. 4A, the spatial error diffusion method is used to diffuse the decimal value of data corresponding to each pixel to neighboring pixels, thereby spatially correcting errors discarded after inverse-gamma correction.

In the spatial error diffusion method, respective error coefficients resulting from respectively multiplying the decimal value of data by specific coefficient rates corresponding to neighboring pixels are diffused to the neighboring pixels. That is, an error coefficient resulting from multiplying the decimal value of inverse-gamma corrected data of a pixel A by a specific coefficient rate 7/16 corresponding to a neighboring pixel B positioned in a direction i is diffused to the pixel B, and an error coefficient resulting from multiplying the decimal value by a specific coefficient rate 1/16 corresponding to a neighboring pixel C positioned in a direction j is diffused to the pixel C. Also, an error coefficient resulting from multiplying the decimal value by a specific coefficient rate 5/16 corresponding to a neighboring pixel D positioned in a direction k is diffused to the pixel D and an error coefficient resulting from multiplying the decimal value by a specific coefficient rate 3/16 corresponding to a neighboring pixel E positioned in a direction I is diffused to the pixel E.

Referring to FIG. 4B, in the inter-pixel error diffusion method, error diffusion is performed in a unit of cell and line. Error coefficients transferred from pixels A, B, C, and D are added to a pixel E and uni-directional diffusion from left to right is carried out.

FIG. 5 shows an image displayed by the error diffusion method performed in the conventional PDP.

As shown in FIG. 5, in the image displayed by the conventional error diffusion method, since an error diffusion coefficient is used for each pixel, the same error diffusion coefficient is applied to Red, Green, and Blue data. That is, artifacts formed by Red, Green, and Blue data existing in the same pixel are represented on the same region.

In the conventional error diffusion method, since an error diffusion coefficient is applied for each pixel, the sizes of artifacts displayed on a screen are different for each pixel(OK?), which deteriorstes picture quality.

### SUMMARY OF THE INVENTION

Accordingly, an object of the present invention is to solve at least the problems and disadvantages of the background art.

The present invention provides a plasma display apparatus, capable of reducing error diffusion noise when image processing to thereby improve picture quality, and an image processing method thereof.

According to an aspect of the present invention, there is provided a plasma display apparatus including: an inverse-gamma correction unit for performing inverse-gamma correction on image data received from the outside; and a halftoning unit for respectively applying different error diffusion coefficients to Red, Green, and Blue image data of the inverse-gamma corrected image data and performing error diffusion.

Therefore, according to the present invention, it is possible to significantly reduce error diffusion artifacts when image processing, thereby displaying a clearer image.

### BRIEF DESCRIPTION OF THE DRAWINGS

The invention will be described in detail with reference to the following drawings in which like numerals refer to like elements:

FIG. 1 shows graphs for comparing the brightness characteristics of a conventional PDP with those of a CRT;

FIG. 2 is a graph for explaining inverse-gamma correction of a conventional PDP;

FIG. 3 is a block diagram for explaining image processing of a conventional PDP;

FIGS. 4A and 4B are views for explaining an error diffusion method used in a conventional PDP;

FIG. 5 shows an image displayed by the error diffusion method performed in the conventional PDP;

FIG. 6 is a block diagram for explaining image processing of a plasma display device according to the present invention;

FIG. 7 is a view for explaining general error diffusion when image processing of the plasma display apparatus according to the present invention;

FIG. 8 shows an error diffusion coefficient table storing error diffusion coefficients to be applied to Red, Green, and Blue cells when image processing of the plasma display device according to the present invention;

FIG. 9 shows a displayed image according to an embodiment of the present invention; and

FIGS. 10A through 10C are views for explaining an error diffusion method used when image processing is performed by the plasma display device according to the present invention.

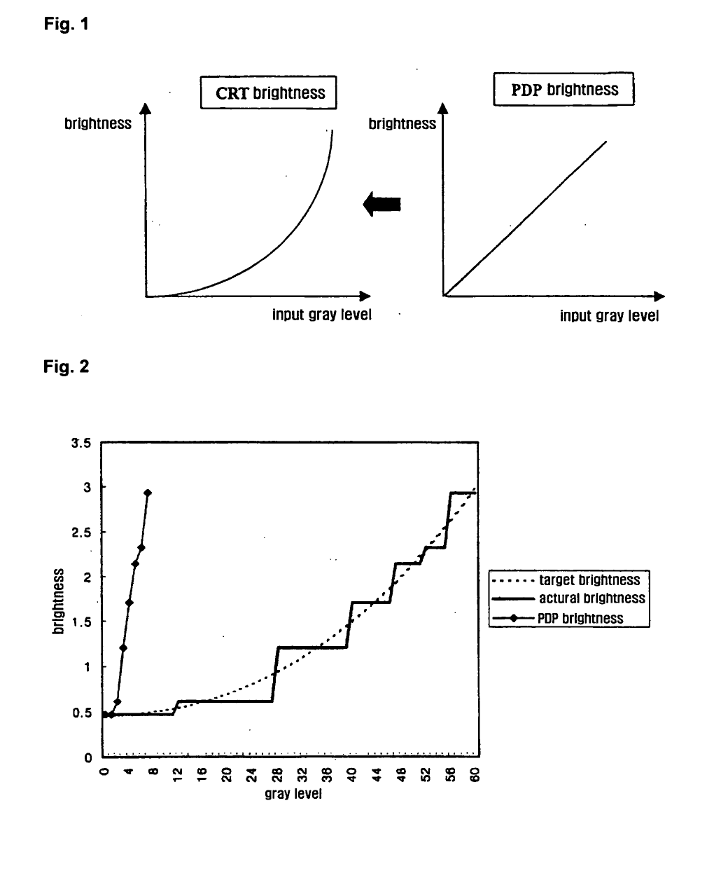

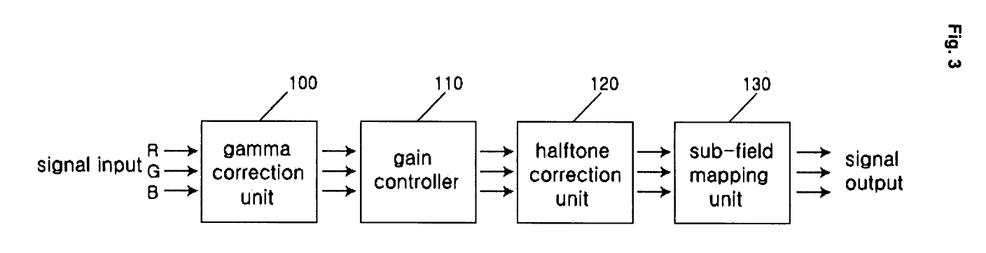

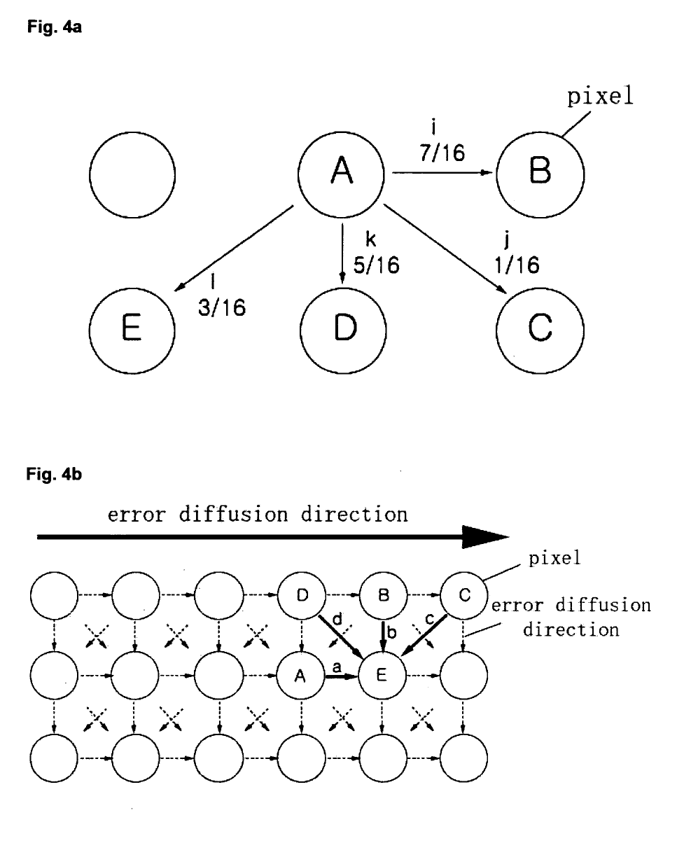

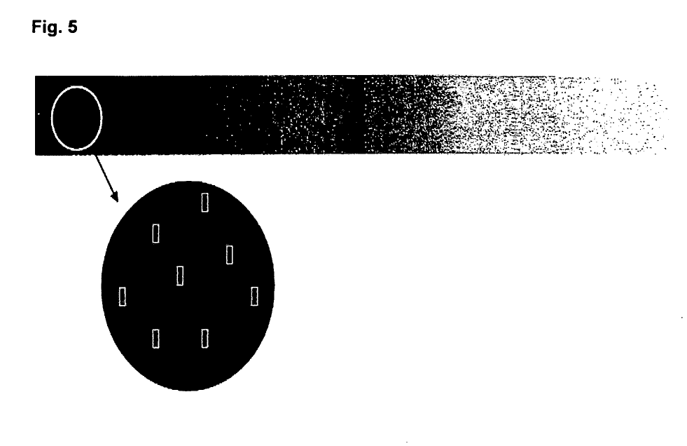

### DETAILED DESCRIPTION OF PREFERRED EMBODIMENTS

Preferred embodiments of the present invention will be described in a more detailed manner with reference to the drawings.

A plasma display device and an image processing method thereof, according to the present invention, are characterized in that inverse-gamma correction is performed on image data applied from the outside and error diffusion is performed in such a manner that different error coefficients are applied to the respective Red, Green, Blue image data of the inverse-gamma corrected image data.

A halftoning unit includes an error coefficient look up table storage unit storing an error coefficient look up table in which different error coefficients correspond to Red, Green, and Blue image data

Error diffusion of Red, Green, and Blue image data is performed in such a manner that Red, Green, and Blue image data to which corresponding error diffusion coefficients are applied are respectively diffused to the Red, Green, and Blue data of each of neighboring cells.

When diffusing the Red, Green, Blue image data to the Red, Green, and Blue image data of each of the neighboring cells, the number of the neighboring cells can be differently set for each of the Red, Green, and Blue image data.

Methods for error diffusion of Red, Green, and Blue image data include a Floyd & Steinberg method, a Javis, Judis & Ninke method, and a Stucki method.

The error diffusion of applying different error coefficients to the Red, Green, and Blue image data of inverse-gamma corrected image data can be performed using a different method for each frame.

Hereinafter, embodiments of the present invention will be described in detail with reference to the appended drawings.

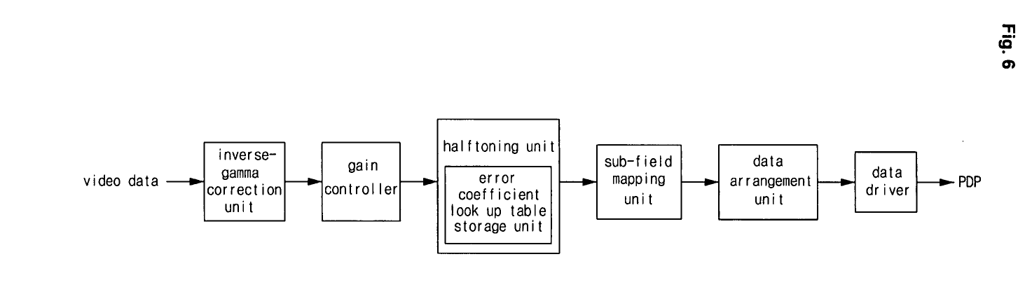

FIG. 6 is a block diagram for explaining image processing of a plasma display apparatus according to an embodiment of the present invention. Referring to FIG. 6, the plasma display apparatus includes an inverse-gamma correction unit 610 for image processing, a gain controller 620, a halftoning unit 630, a sub-field mapping unit 640, a data arrangement unit 650, and a data driver 660. Image processing performed by the plasma display device is described below.

First, the inverse-gamma correction unit 610 gamma-corrects received image signal data using pre-stored gamma data and performs linear transform on a brightness value corresponding to a gray level of the image signal data.

The gain controller 620 amplifies valid gains of the Red, Green, and Blue image signal data corrected by the inverse-gamma correction unit 610.

The halftoning unit 630 reflects an error generated when a pixel corresponding to the Red, Green, and Blue image signal data whose valid gains are amplified is quantized, to neighboring pixels, thereby improving gray-level representation capability. Methods for error diffusion of Red, Green, and Blue image signal data to neighboring pixels include a Floyd & Steinberg method, a Javis, Judis and Ninke method, and a Stucki method, which will be described later. When error diffusion to neighboring pixels is performed, a different error coefficient is applied to each of Red, Green, and Blue image signal data. Such error diffusion can be performed using a different method for each frame. Also, the number of the neighboring pixels can be differently set for each of Red, Green, and Blue image signal data.

Meanwhile, the error coefficients that will be respectively applied to Red, Green, and Blue image data are stored in an error coefficient look up table storage unit. The error coefficient look up table storage unit 630a may be provided independently from the halftoning unit 630. However, as shown in FIG. 6, the error coefficient look up table storage unit 630 is preferably included in the halftoning unit 630 to perform image processing.

The sub-field mapping unit 640 maps the Red, Green, and Blue data received from the halftoning unit 630 to a pre-set sub-field mapping table.

The data arrangement unit 650 converts video data received from the sub-field mapping unit 640 into the resolution format of PDP.

Thereafter, the data driver 660 applies a driving signal to address electrodes of the PDP to thus implement an image of the video data converted by the data arrangement unit 650.

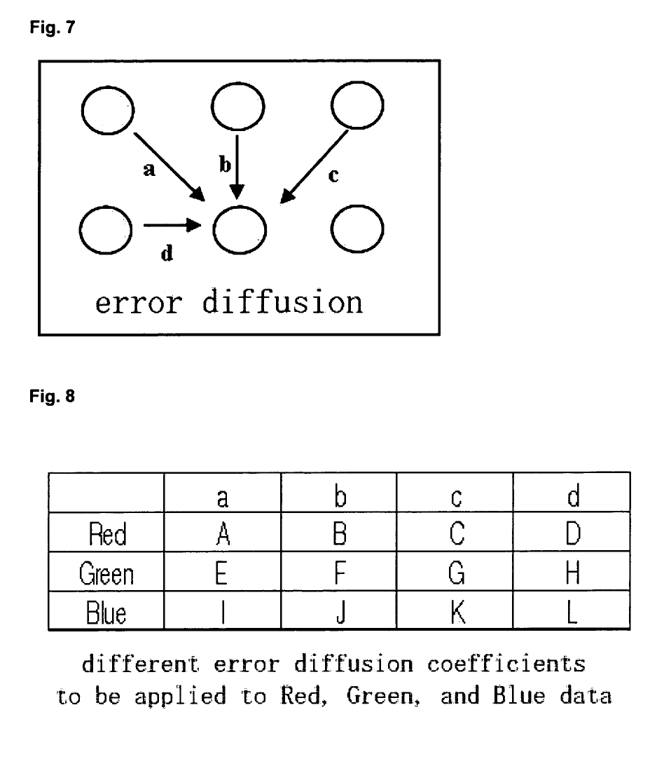

FIG. 7 is a view for explaining general error diffusion performed by the halftoning unit, in which the gray levels of neighboring pixels affect each other, when image processing of the plasma display apparatus according to the present invention. FIG. 8 shows an error diffusion coefficient table storing error diffusion coefficients to be applied to Red, Green, and Blue cells when image processing of the plasma display apparatus according to the present invention.

Referring to FIG. 8, different error diffusion coefficients are applied according to the gray levels of the Red, Green, and Blue cells of each of neighboring pixels. The error diffusion values of the Red, Green, and Blue cells are error-diffused by the halftoning unit 630, as shown in FIG. 7, thus correcting a gray level.

That is, a table including information for error diffusion coefficients assigned to the gray levels of Red, Green, and Blue cells is stored in a memory (error coefficient look up table storage unit) 630a installed in the halftoning unit 630, so to apply a different error diffusion coefficient to each Red, Green, and Blue data and allow the gray levels of adjacent cells to continuously affect each other by error diffusion.

A process for applying different error coefficients to the respective Red, Green, and Blue data of the inverse-gamma corrected data will be described below.

In error diffusion of Red data, a corresponding coefficient is applied to the Red data of the inverse-gamma corrected data using a data table storing information of the coefficient and the inverse-gamma corrected Red data to which the coefficient is applied is diffused to the Red data of a neighboring cell.

In error diffusion of Green data, a corresponding coefficient is applied to the Green data of the inverse-gamma corrected data using a data table storing information of the coefficient and the inverse-gamma corrected Green data to which the coefficient is applied is diffused to the Green data of a neighboring cell.

In error diffusion of Blue data, a corresponding coefficient is applied to the Blue data of the inverse-gamma corrected data using a data table storing information of the coefficient and the inverse-gamma corrected Blue data to which the coefficient is applied is diffused to the Blue data of a neighboring cell.

When diffusing the Red, Green, and Blue data of the inverse-gamma corrected data to the respective Red, Green, and Blue data of each of the neighboring cells, the number of the neighboring cells can be differently set for each of the Red, Green, and Blue data.

Now, the above process is described in detail using Equation.

A Red gray level obtained by error diffusion of the Red data satisfies the following Equation 1.

$$E + ( \frac{3}{16} {Red}_{a} ) + ( \frac{5}{16} {Red}_{b} ) + ( \frac{1}{16} {Red}_{c} ) + ( \frac{7}{16} {Red}_{d} ) = {E}_{Red} \qquad ( 1 )$$

Here, E represents the gray level of a pixel to which error diffusion values will be applied using the gray levels of adjacent pixels.

Redₐ represents the Red gray level of a pixel to which a coefficient 3 is applied among adjacent pixels surrounding the pixel with the gray level E.

Red_{b} represents the Red gray level of a pixel to which a coefficient 5 is applied among adjacent pixels surrounding the pixel with the gray level E.

Red_{c} represents the Red gray level of a pixel to which a coefficient 1 is applied among adjacent pixels surrounding the pixel with the gray level E.

Red_{d} represents the Red gray level of a pixel to which a coefficient 7 is applied among adjacent pixels surrounding the pixel with the gray level E.

E_{Red} represents the Red gray level of the pixel with the gray level E, to be represented by error diffusion using the Red gray levels of the adjacenet pixels.

A Green gray level obtained by error diffusion of the Green data satisfies the following Equation 2.

$$E + ( \frac{3}{16} {Green}_{a} ) + ( \frac{5}{16} {Green}_{b} ) + ( \frac{1}{16} {Green}_{c} ) + ( \frac{7}{16} {Green}_{d} ) = {E}_{Gree {n}_{\sim}} \qquad ( 2 )$$

Here, E represents the gray level of a pixel to which error diffusion values will be applied using the gray levels of adjacent pixels.

Greenₐ represents the Green gray level of a pixel to which a coefficient 3 is applied among adjacent pixels surrounding the pixel with the gray level E.

Green_{b} represents the Green gray level of a pixel to which a coefficient 5 is applied among adjacent pixels surrounding the pixel with the gray level E.

Green_{c} represents the Green gray level of a pixel to which a coefficient 1 is applied among adjacent pixels surrounding the pixel with the gray level E.

Green_{d} represents the Green gray level of a pixel to which a coefficient 7 is applied among adjacent pixels surrounding the pixel with the gray level E.

E_{Green} represents the Green gray level of the pixel with the gray level E, to be represented by error diffusion using the Green gray levels of the adjacenet pixels.

A Blue gray level obtained by error diffusion of the Blue data satisfies the following Equation 3.

$$E + ( \frac{3}{16} {Blue}_{a} ) + ( \frac{5}{16} {Blue}_{b} ) + ( \frac{1}{16} {Blue}_{c} ) + ( \frac{7}{16} {Blue}_{d} ) = {E}_{Blue} \qquad ( 3 )$$

Here, E represents the gray level of a pixel to which error diffusion values will be applied using the gray levels of adjacent pixels.

Blueₐ represents the Blue gray level of a pixel to which a coefficient 3 is applied among adjacent pixels surrounding the pixel with the gray level E.

Blue_{b} represents the Blue gray level of a pixel to which a coefficient 5 is applied among adjacent pixels surrounding the pixel with the gray level E.

Blue_{c} represents the Blue gray level of a pixel to which a coefficient 1 is applied among adjacent pixels surrounding the pixel with the gray level E.

Blue_{d} represents the Blue gray level of a pixel to which a coefficient 7 is applied among adjacent pixels surrounding the pixel with the gray level E.

E_{Blue} represents the Blue gray level of the pixel with the gray level E, to be represented through error diffusion using the Blue gray levels of the adjacenet pixels.

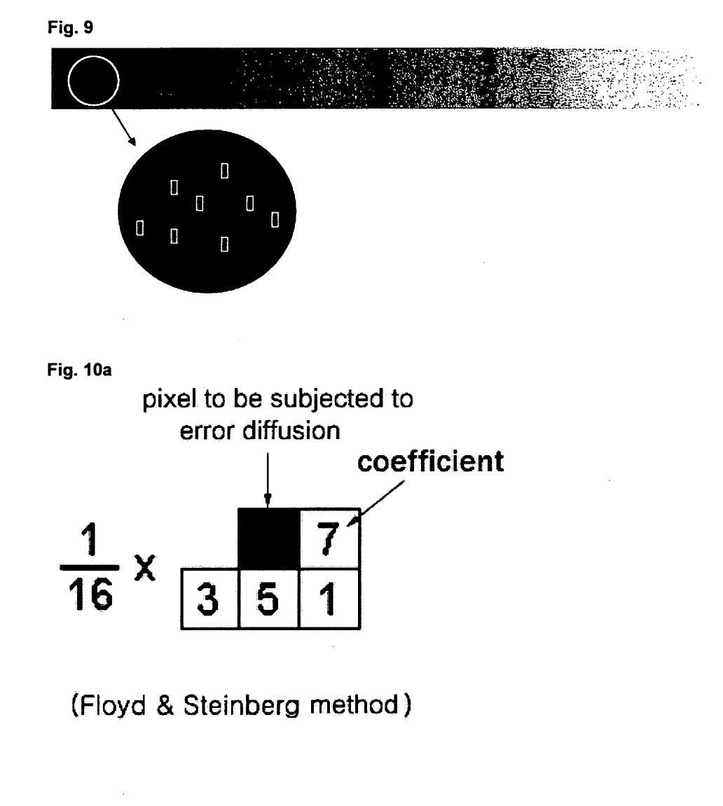

FIG. 9 shows a displayed image according to an embodiment of the present invention.

As shown in FIG. 9, since different error diffusion coefficients are applied to respective Red, Green, and Blue cells, error diffusion artifacts are respectively displayed for respective Red, Green, and Blue cells, instead of being respectively displayed for respective pixels.

Therefore, artifacts for Red, Green, and Blue data appear separately at different regions without appearing at the same region.

As a result, when an image is displayed on a screen, the amount of error diffusion artifacts that can be sensed by a viewer's eyes is reduced.

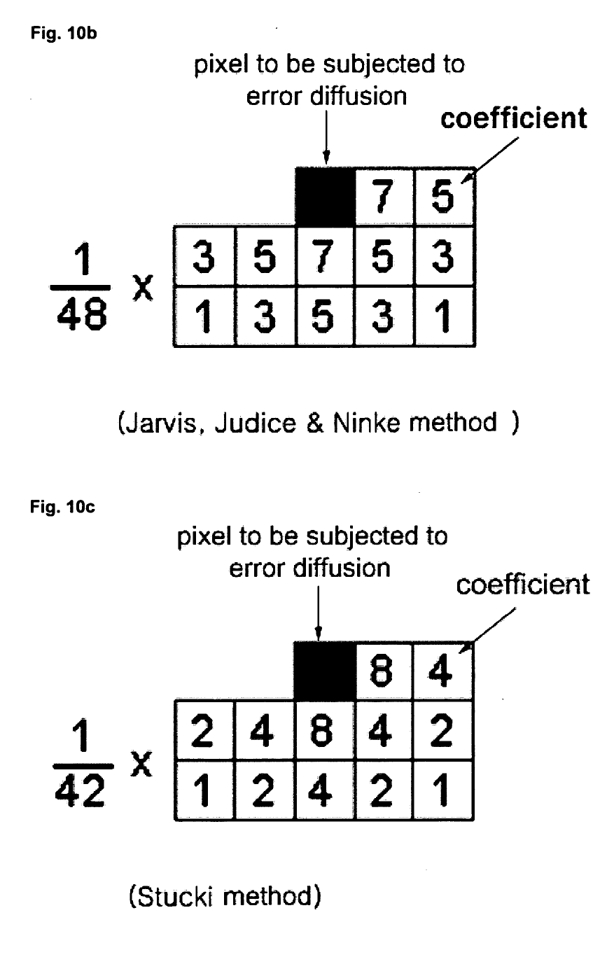

FIGS. 10A through 10C are views for explaining an error diffusion method used when image processing is performed by the plasma display apparatus according to the present invention.

Referring to FIG. 10A, error diffusion coefficients 3, 5, 1, and 7 into which a reference numeral 16 is divided are applied to the respective Red, Green, and Blue cells of each of adjacent pixels. This error diffusion method is called a Floyd & Steinberg method.

Referring to FIG. 10B, error diffusion coefficients 1, 3, 5, 3, 1, 3, 5, 7, 5, 3, 5, and 7 into which a reference numeral 48 is divided are applied to the respective Red, Green, and Blue cells of each of adjacent pixels. This error diffusion method is called a Jarvis, Judice, & Ninke method.

Also, referring to FIG. 9C, error diffusion coefficients 1, 2, 4, 2, 1, 2, 4, 8, 4, 2, 4, and 8 into which a reference numeral 42 is divided are applied to the respective Red, Green, and Blue cells of each of adjacent pixels. This error diffusion method is called a Stucki method.

As described above, by applying different error diffusion coefficients to Red, Green, and Blue data and employing various error diffusion methods, it is possible to significantly reduce error diffusion artifacts.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus comprising:
an inverse-gamma correction unit performing inverse-gamma correction on image data applied from the outside; and
a halftoning unit respectively applying different error coefficients to Red, Green, and Blue image data of the inverse-gamma corrected image data and performing error diffusion of the Red, Green, and Blue image data to which the different error coefficients are applied.

2. The plasma display apparatus of claim 1, wherein the halftoning unit includes an error coefficient look up table storage unit storing error coefficients to be differently applied to the Red, Green, and Blue image data.

3. The plasma display apparatus of claim 1, wherein, when performing error diffusion of the Red, Green, and Blue image data, the Red, Green, and Blue image data to which the different error coefficients are applied are diffused to respective Red, Green, and Blue data of each of neighboring cells.

4. The plasma display apparatus of claim 3, wherein, when the Red, Green, and Blue image data are diffused to the respective Red, Green, and Blue data of each of the neighboring cells, the number of the neighboring cells are differently set for each of the Red, Green, and Blue data.

5. The plasma display apparatus of claim 1, wherein the error diffusion of the Red, Green, and Blue image data is performed using at least one of a Floyd & Steinberg method, a Javis, Judis & Ninke method, and a Stucki method.

6. The plasma display apparatus of claim 1, wherein the error diffusion of the Red, Green, and Blue data to which the different error coefficients are applied, is performed using a different method for each frame.

7. An image processing method of a plasma display apparatus, comprising the steps of:
performing inverse-gamma correction on image data applied from the outside; and
respectively applying different error coefficients to Red, Green, and Blue data of the inverse-gamma corrected image data and performing error diffusion and halftoning of the Red, Green, and Blue data to which the different error coefficients are applied.

8. The image processing method of claim 7, wherein, when performing the error diffusion of the Red, Green, and Blue image data, the Red, Green, and Blue image data to which the different error coefficients are applied are diffused to respective Red, Green, and Blue image data of each of neighboring cells.

9. The image processing method of claim 8, wherein, when the Red, Green, and Blue image data are diffused to the respective Red, Green, and Blue image data of each of the neighboring cells, the number of the neighboring cells are differently set for each of the Red, Green, and Blue data.

10. The image processing method of claim 7, wherein the error diffusion of the Red, Green, and Blue data is performed using at least one of a Floyd & Steinberg method, a Javis, Judis & Ninke method, and a Stucki method.

11. The image processing method of claim 7, wherein the error diffusion of the Red, Green, and Blue data to which the different error coefficients are applied, is perforemed using a different method for each frame.
